(19) United States
(12) Patent Application Publication
(10) Pub. No.: US 2007/0261962 A1
(43) Pub. Date: Nov. 15, 2007

(54) Separation Systems with Charge Mosaic Membrane

(76) Inventor: Ryszard Gajek, Martinez, CA (US)

Correspondence Address: FISH & ASSOCIATES, PC;ROBERT D. FISH, 2603 Main Street, Suite 1050, Irvine, CA, 92614-6232, US

(21) Appl. No.: 11/769,182

(22) Filed: Jun. 27, 2007

Related U.S. Application Data
(63) Continuation-in-part of application No. 10/506,517, filed on Sep. 2, 2004.

(51) Int. Cl. C02F 1/42

(52) U.S. Cl. 204/660

(57) ABSTRACT

An ion is eluted from an ion exchange resin in a separation system using an eluent generated by electrolysis of a medium. Elution is further assisted by an electrical field between two electrodes, wherein the ion exchange resin is at least partially disposed between the electrodes. Particularly preferred aspects of such separation systems include gradient separation (Membrane Dynamically Scanned Electrophoresis—MDSE) and buffered electrodialysis (Dynamically Buffered Electrodialysis—DBE).

This application is a continuation-in-part of our copending application with the Ser. No. 10/506,517, filed Sep. 2, 2004 which is a national phase of International patent application with the serial number PCT/US02/10444, filed Apr. 2, 2002, both of which are incorporated in their entirety by reference herein.

### FIELD OF THE INVENTION

The field of the invention is electrophoresis-assisted separation of ionic species.

### BACKGROUND OF THE INVENTION

Numerous disciplines in science and technology require separation and/or analysis of complex mixtures, or quantification, concentration, and/or removal of various analytes from such mixtures and there are various separation technologies known in the art.

For example, individual analytes can be separated or isolated from mixtures using molecular weight differences between the analyte and the remaining compounds in the mixture. Size discrimination may be performed by size exclusion (e.g., using microporous matrix) or by molecular sieving (e.g., using crosslinked matrix). While separations based on molecular weight differences are typically relatively independent on buffer conditions and other extraneous factors, resolution between analytes will often become increasingly problematic as the molecular weight difference decreases.

In another example, individual analytes can be separated or isolated from mixtures using differences in hydrophobicity between the analyte and the remaining compounds in the mixture. Numerous separation systems that employ such differences are known in the art, and among other systems, reversed phase high performance liquid chromatography (HPLC) affords a relatively high resolution among relatively chemically similar compounds. However, many of such systems are difficult to operate when the volume of the sample is relatively large (e.g., several liters). Furthermore, HPLC systems are relatively expensive and frequently require extensive maintenance.

Alternatively, individual analytes can be separated or isolated from mixtures using differences in their net charge at a particular pH and/or ionic strength in the sample. Typically such systems include a cation exchange material or an anion exchange material to which one or more analytes are bound and eluted using an external elution reagent. Ion exchange separation is a relatively common separation technology that is in many cases inexpensive and frequently has a desirable resolution. However, various difficulties remain. Among other things, elution of a bound analyte will place the analyte in an environment that may not be compatible with further use or that may even interfere with the analyte's integrity of function.

Still further, analytes may be separated or isolated from mixtures using differences in their affinity towards a typically immobilized and highly specific binding agent. Such affinity chromatographic separations are generally highly specific and frequently allow gentle separation of the analyte from the binding agent. However, many affinity reagents are relatively expensive (e.g., monoclonal antibodies) or may not be available for a desired analyte.

In still further known systems, two or more physico-chemical properties of an analyte are employed for separation of the analyte from a mixture of compounds. For example, isoelectric focusing combines pH-dependent variability of an analyte with electric mobility of the analyte in an electrophoresis-type of separation. In another example, gel electrophoresis employs molecular weight and electric charge of an electrolyte. While many of the separation systems improve at least some aspects of resolution of a desired analyte, various problems still remain. For example, analyte recovery is frequently problematic. Furthermore, large scale preparation of analytes is often impracticable. Thus, despite various known configurations and methods for separation of an analyte from a medium, all or almost all suffer from various problems. Therefore, there is still a need to provide improved configurations and methods for separation systems.

### SUMMARY OF THE INVENTION

The present invention is directed to configurations and methods of a separation system in which an analyte in ionic form is eluted from an ion exchange resin using an electric field and an eluent, wherein the electric field and the eluent are generated by a pair of electrodes in the system.

In one aspect of the inventive subject matter, contemplated systems comprise a cathode, an anode, and a first ion (e.g., anion) bound by a first ion exchange resin (e.g., anion exchange resin) that is at least partially disposed between the cathode and the anode and that is separated from at least one of the anode and cathode (e.g., cathode) by a charge mosaic membrane (CMM), wherein the cathode, the anode, and the ion exchange resin are at least partially disposed in a medium, and wherein the first ion detaches from the ion exchange resin at (a) a particular voltage applied between the anode and cathode and (b) a particular electroactivity of a second ion (e.g., hydroxyl ion) generated by electrolysis of the medium (e.g., water).

Particularly contemplated systems comprise a second ion exchange resin (e.g., cation exchange resin) at least partially disposed between the anode and the first ion exchange resin, wherein a cation exchange membrane is at least partially disposed between the first and second ion exchange resin.

Thus, viewed from another perspective, contemplated systems may comprise an ion exchange resin that binds an ion from a fluid, wherein the ion is eluted from the resin using (a) an electric field generated between a cathode and an anode and (b) a second ion that is generated by electrolysis of the fluid by the cathode and the anode. In such systems, it is preferred that a charge mosaic membrane separates the ion exchange resin from the cathode, thereby allowing migration of OH⁻ ions from the cathode to the ion exchange resin and migration of cations from the ion exchange resin to the cathode.

It should therefore be appreciated that in contemplated systems and methods separation will predominantly be due to (a) molecular sieving in which small molecules diffuse to the inside of the polyelectrolyte layer while larger molecules will remain on the surface of the layer, and (b) differential migration of the molecules which is proportional to the electric mobility of the molecules in the sample regardless of their position relative to the polyelectrolyte layer. It should be especially recognized that the electric migration will be (in terms of an electrolyte model) within the Helmholtz layer and sometimes within the Stern layer provided there is more then one layer of moving ions on the screen surface. In contrast, in capillary electrophoresis (CE) all ions are moving in Smoluchowski or Einstein/Smoluchowski region, where “communication” with the electrode is exclusive through moving charges.

In the inventive subject matter presented herein, it should be noted that the electric field is transmitted to moving ions trough the highly conductive layer of polyelectrolyte. Moreover, in CE and in contrast to the inventive subject matter, the composition of the electrolyte and sample are adjusted (typically by adding a specific buffer) to effect a slightly negative charge on moving molecules, which in some cases causes migration of selected molecules in a direction opposite to that required for analysis as the buffer may cause generation of a slightly positive charge for those molecules (this effect can also be observed in gel electrophoresis).

In a still further aspect of the inventive subject matter, contemplated systems may be employed to separate multiple components from a sample for analytical or preparative purposes. Especially contemplated fluids and/or media include crude, partially purified and/or highly purified preparations/isolates from various sources, including (bio) synthetic fluids, biological fluids, waste fluids, etc. Viewed from yet another perspective, contemplated systems may include a charge mosaic membrane coupled to an ion exchange resin that binds an ion from a fluid and wherein the ion is eluted at least in part from the resin using an eluent that is generated by electrolysis of the fluid.

Various objects, features, aspects, and advantages of the present invention will become more apparent from the following detailed description of preferred embodiments of the invention, along with the accompanying drawing.

### BRIEF DESCRIPTION OF THE DRAWING

FIG. 1 is a schematic view of an exemplary CMM gradient separation (Membrane Dynamically Scanned Electrophoresis—MDSE) system.

FIG. 2 is a schematic view of an exemplary CMM buffered electrodialysis (Dynamically Buffered Electrodialysis—DBE) system.

FIG. 3 is a schematic view of an exemplary practical CMM buffered electrodialysis (Membrane Dynamically Scanned Electrophoresis—MDSE) system.

FIG. 4 is a schematic view of an exemplary practical CMM gradient electrophoresis (Dynamically Buffered Electrodialysis—DBE) system.

### DETAILED DESCRIPTION

The inventor has discovered that ions may be selectively eluted from an ion exchange resin using an electric field and an eluent, wherein the electric field and the eluent are generated by electrodes that are proximal to an ion exchange screen.

More specifically, the inventors discovered that a separation system may comprise a charge mosaic membrane coupled to an ion exchange resin that binds an ion from a fluid and wherein the ion is eluted at least in part from the resin using an eluent that is generated by electrolysis of the fluid. Viewed from another perspective, contemplated separation systems may include an ion exchange resin that binds an ion from a fluid, wherein the ion is eluted from the resin using (a) an electric field generated between a cathode and an anode and (b) a second ion that is generated by electrolysis of the fluid by the cathode and the anode.

In a particularly preferred configuration, a separation system has a cathode, an anode, and a first ion bound by a first ion exchange resin that is at least partially disposed between the cathode and the anode and separated from at least one of the anode and cathode by a charge mosaic membrane, wherein the cathode, the anode, and the ion exchange resin are at least partially disposed in a medium, and wherein the first ion is eluted from the resin using (a) a particular voltage that is applied between the anode and cathode and (b) a second ion that is generated by electrolysis of the medium and moves from the cathode to the anode by the electric field generated by the particular voltage.

As used herein, the terms “ion bound by an ion exchange resin” and “ion exchange resin that binds an ion” refer to non-covalent, ionic binding between the ion and an ionic or polar group of the ion exchange resin. Consequently, the terms “the ion is eluted from the resin” and “the ion elutes from the resin” refer to breaking of the non-covalent, ionic bond between the ion and an ionic or polar group of the ion exchange resin, wherein the breaking of the bond may be effected by (a) an electric field force that attracts the ion towards an electrode with opposite polarity, (b) competition for the ionic or polar group of the ion exchange resin by another ion (same type of ion at higher concentration and/or different ion), and/or (c) kinetic forces acting on the ion (e.g., heat, molecular collisions, etc.).

As also used herein, the term “disposed between the cathode and the anode” refers to a position that intersects or coincides with part of at least one of a plurality of straight lines between the cathode and the anode. Similarly, the term “disposed between the cathode (or anode) and the first ion exchange resin” refers to a position that intersects or coincides with part of at least one of a plurality of straight lines between the cathode (or anode) and the first ion exchange resin.

As still further used herein, the term “charge mosaic membrane” refers to a membrane or other support that includes a plurality of charged groups, wherein some of the charged groups are positively charged (e.g., quaternary ammonium groups), wherein other groups are negatively charged (e.g., sulfonic acid groups), and wherein the plurality of charged groups are disposed in the membrane or other support such that selected cations and anions (e.g., H⁺ and OH⁻) can penetrate the membrane or other support while blocking transport of solvent and/or other ions (e.g., proteins with MW of about 30,000 Dalton).

It should be especially noted that there are fundamental differences between amphoteric and charge-mosaic membranes (CMM): Among other things, amphoteric membranes are usually prepared by chemical grafting of two different monomers, one of which contains cation-exchange groups while the other contains anion-exchange groups (e.g., A. Elmidaoui, et al., J. Polym Sci, Part B: Polym. Physics; 29 (6) 705-13, 2003: Synthesis and characterization of amphoteric ion-exchange membrane grafted acrylic acid and amino-2-ethyl methacrylate on ozonized polyethylene). As a result, both types of ion-exchange groups are in molecular distance from each other inside swollen amphoteric membrane pores, and the solvent in the pores additionally contains two types of mobile ions of opposite charges. This kind of ion-exchange membranes is usually used for dialytic separation of electrolytes from non-electrolyte solutes, where both types of mobile ions are transported in one direction. Dialytic transport is caused by difference of chemical potential on both sides of the amphoteric membrane. On the other hand when electric potential is applied across the amphoteric membrane, cations and anions are moving in opposite directions, combined with concentration polarization on both sides, the mobile ions can be removed from pores and fixed ion-exchange groups can create “ionomeric” bonds, usually associated with depletion of water content and the membrane substantially loses its ability to selectively transport ionic solutes.

In contrast, the distinctive morphological feature of a CMM is the physical separation of its cation/anion exchange regions, which transport ions of opposite charges. Anion- and cation-exchange elements of the CMM exhibit typical properties of equivalent cation and anion-exchange membranes respectively, and especially great electrochemical stability even at high electric current flow. Thus, if an amphoteric membrane was used in the examples described below instead of a CMM, both ionic streams would interfere with each other at the membrane surface and thus make it impossible to accurately control and maintain ion flow through the membrane. Moreover large sample ions with low electrical mobility would not be able to flow in opposite direction to the hydronium or hydroxyl ions, and remain at the surface or become trapped inside pores of amphoteric membrane (especially if the steric effect would hinder the flow) and effectively alternating the steady flow of hydronium or hydroxyl ions. This is reflected in the fact that there is no report in the art that described use of amphoteric membranes in electrodeionization processes, even though such membranes were described more than 50 years ago (e.g., U.S. Pat. No. 2,815,320).

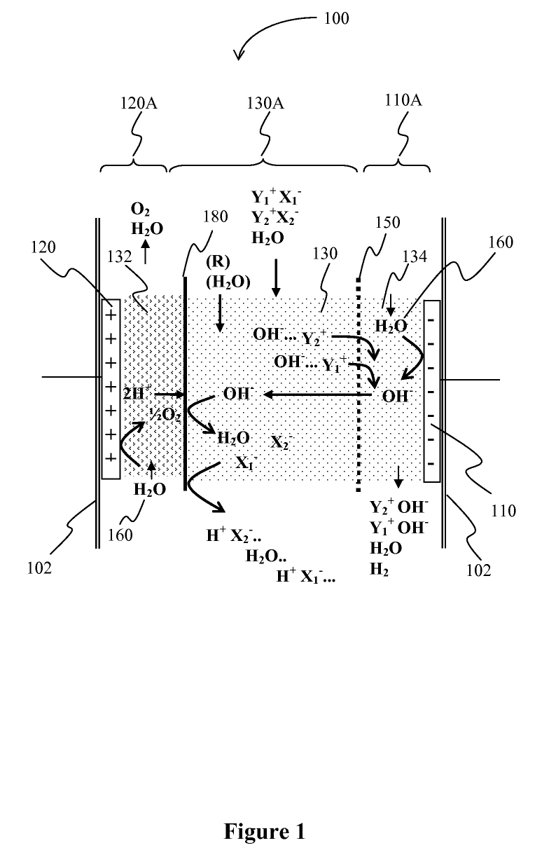

In an especially preferred aspect of the inventive subject matter, an exemplary separation system is configured to operate as a CMM-gradient (MDSE) separation system. Here, as depicted in FIG. 1 a CMM separation system 100 has a housing 102 that at least partially encloses an anode compartment 120A with anode 120, a cathode compartment 110A with cathode 110, and an analyte compartment 130A that is separated from the anode compartment 120A via cation exchange membrane 180 and that is separated from the cathode compartment 110A via charge mosaic membrane 150. The anode compartment 120A further includes cation exchange resin 132, while the analyte compartment 130A and the cathode compartment 110A include anion exchange resin 130 and 134, respectively.

Anode, cathode, and analyte compartment further include medium comprising water 160. At least a portion of the water is electrolyzed via the anode and cathode, wherein oxygen evolves in the anode compartment, hydrogen evolves in the cathode compartment, and wherein H⁺ is generated in the anode compartment and OH⁻ is generated in the cathode compartment. The protons generated in the anode compartment will be (via cation exchange resin and cation exchange membrane) transported to the analyte compartment and further (via charge mosaic membrane) to the cathode compartment. Similarly, the OH⁻ ions generated in the cathode compartment will be transported (via anion exchange resin and charge mosaic membrane) into the analyte compartment comprising anion exchange resin. However, further passage of the OH⁻ ions to the anode compartment is blocked by the cation exchange membrane.

A sample comprising ionic species Y₁⁺X₁⁻ and Y₂⁺X₂⁻ in water is applied to the analyte compartment, and the anionic portions of the sample X₁⁻ and X₂⁻ will be bound to the anion exchange resin in the analyte compartment. Upon application of an electric potential between the anode and the cathode, an electric force will act upon the bound anions. Furthermore, electrolysis of water by the electrodes will proved OH⁻ anions that will move from the cathode compartment via the anion exchange resin to the analyte compartment. Thus, an increasing electrical potential between the electrodes will act in at least two ways upon the anions bound to the anion exchange resin in the analyte compartment. First, an electrophoretic force will increasingly move the bound anions according to their strength with which they bind to the anion exchange material. Second, the OH⁻ ions in the analytic compartment will increasingly compete for interaction with the anion exchange resin. Consequently, it should be recognized that a particular anion will elute from the anion exchange resin by (a) generation of (and competition with) an anion that is generated from the medium by electrolysis, and (b) at a particular voltage applied to the anode and cathode via an electrophoretic effect (see also below).

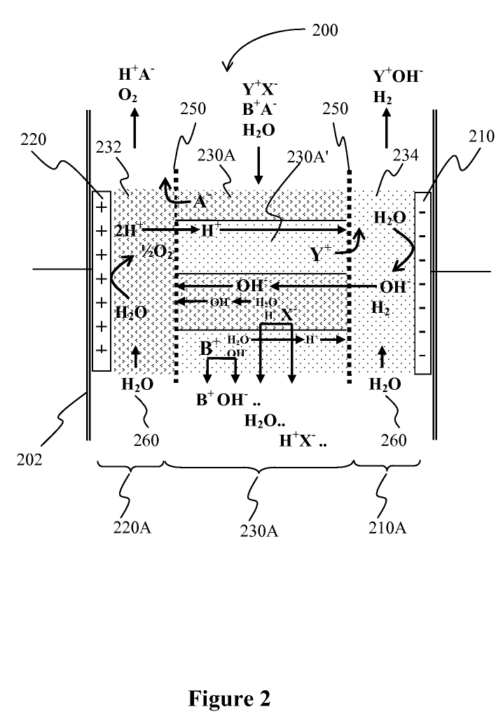

Alternatively, as depicted in FIG. 2, an exemplary separation system is configured to operate as a CMM-buffered electrodialysis (Dynamically Buffered Electrodialysis) system. Here, the separation system 200 has a housing 202 that at least partially encloses cathode 210 and anode 220. The housing cooperates with charge mosaic membranes 250 to define an anode compartment 220A, an analyte compartment 230, and a cathode compartment 210A. The anode compartment 220A is at least partially filled with cation exchange resin 232 while the cathode compartment 210A is at least partially filled with anion exchange resin 234. The analyte compartment includes an ordered mixed bifunctional screen comprising alternate layers of cation exchange resin 230A and anion exchange resin 230A′.

Anode, cathode, and analyte compartment further include medium comprising water 260. At least a portion of the water is electrolyzed via the anode and cathode, wherein oxygen evolves in the anode compartment, hydrogen evolves in the cathode compartment, and wherein H⁺ is generated in the anode compartment and OH⁻ is generated in the cathode compartment. The protons generated in the anode compartment will be (via cation exchange resin and cation exchange membrane) transported to the analyte compartment and further (via cation exchange resin and charge mosaic membrane) to the cathode compartment. Similarly, the OH⁻ ions generated in the cathode compartment will be transported (via anion exchange resin and charge mosaic membrane) into the analyte compartment comprising anion exchange resin, and further (via anion exchange resin and charge mosaic membrane) to the cathode compartment.

An aqueous sample comprising ionic species Y⁺X⁻ and B⁺A⁻ is applied to the analyte compartment, and the anionic portions of the sample X⁻ and A⁻ will be bound to the anion exchange resin in the analyte compartment. Similarly, the cationic portions of the sample Y⁺ and B⁺ will be bound to the cation exchange resin in the analyte compartment. Upon application of an electric potential between the anode and the cathode, an electric force will act upon the bound anions and cations. Furthermore, electrolysis of water by the electrodes will provide OH⁻ anions and protons that will move from the electrode of their origin to the electrode with opposite polarity.

Thus, an increasing electrical potential between the electrodes will act in at least two ways upon the anions and cations bound to the anion and cation exchange resin in the analyte compartment. First, an electrophoretic force will increasingly move the bound anions cations according to their strength with which they bind to the ion exchange material. Second, the OH⁻ ions and protons in the analytic compartment will increasingly compete for interaction with the anion exchange resin as the electric field strength increases. Consequently, it should be recognized that a particular anion and a particular cation will elute from the ion exchange resin by (a) generation of (and competition with) an anion and cation that is generated from the medium by electrolysis, and (b) at a particular voltage applied to the anode and cathode (via an electrophoretic effect).

It should be especially recognized that dynamic buffering in the DBM system is a result of two dynamic factors (e.g., electric and hydraulic gradient) present in the system, which can be viewed as follows: Cation- and anion-exchange layers (230A and 230A′ respectively) of the screen in the space 230 will bind sub-saturation quantities (total ion-exchange capacity of the screen is not exhausted) of any acid and/or base flowing into it and the pH of the solution in 230 will thus be equal 7. Larger molecules (anionic, cationic or amphoteric) will attach to the surface of the layers while small molecules or ions will diffuse to the inner layers of the screen. When electric and hydrodynamic gradients (which are perpendicular to each other) are generated at increasing strength, the energy required to dissociate water molecules in OH⁻ and H⁺ will first be lower than the energy required to detach surface-bound molecules. As the gradients further increase, the surface-bound molecules will became “water-born” after acquiring the respective counter ions provided by the water dissociation. The order of detaching will thus depend on the binding energy of separated molecules. As a result acidic, basic or amphoteric molecules will be eluted at different strength of the total “dynamic gradient” working in the system. At rare occasion, when some acidic and basic components of the sample would be eluted at exactly same dynamic gradient value from separate parts of screen 230A, they can recombine (FIG. 2) and create a salt molecule. Once the molecules are flowing in the solution, they cannot reattach themselves to the screen, even if they are dissociated and the pH will be different then 7 and will leave the system. Such situation can be considered as an equivalent to exhausted capacity of classic buffer solution.

With respect to the housing, it is contemplated that the size, configuration and material may vary considerably, and a particular housing will typically be determined at least in part by the particular function of the device and type of sample. However, it is generally contemplated that the housing is configured to at least partially enclose the cathode compartment, the analytical compartment, and/or the anode compartment. Furthermore, suitable housings typically enclose at least part of the electrodes (which may also be integral part of the housing). Moreover, it is generally preferred that the materials for the housing (or at least the materials contacting the anode, analyte, and cathode compartment are chemically and electrically inert (i.e., do not react with a desired analyte and/or solvent and have a resistivity of at least 1 M-ohm).

Consequently, suitable housings may be fabricated from numerous materials, and contemplated materials include natural and synthetic polymers, metals, glass, and all reasonable combinations thereof. Furthermore, where contemplated devices are employed to isolate one or more analytes from a relatively large volume (e.g., several liters to several hundred liters, and even more), the housing may be configured as a tank, and the separation may be performed batch-wise. On the other hand, where a continuous flow of sample is preferred, the housing may be configured as a column (i.e., generally cylindrical with open ends).

Similarly, contemplated electrodes may be manufactured from a variety of materials, and it is generally contemplated that the particular nature of an electrode will at least partially depend on the particular sample, size of the electrode, and/or strength of the electric field. However, in especially preferred aspects of the inventive subject matter, suitable electrodes include platinum, or platinum-coated electrodes, gold, or gold-coated electrodes, silver or silver-coated electrodes, graphite electrodes, etc.

With respect to the size and positioning of suitable electrodes, it is generally preferred that the electrodes are sized and positioned such that (a) the electric field between the electrodes overlaps at least in part with the analyte compartment, and (b) that the electrodes contact the medium such that at least part of the OH⁻ ions generated by the cathode will migrate towards the anode (preferably at least across the CMM membrane into the analyte compartment). Thus, suitable electrodes may be configured as wires, plates, grids, or even as integral parts of the housing. Furthermore, it should be appreciated that while in some preferred configurations the electrodes are juxtaposed at the same height, other electrode configurations include those in which the height of one electrode is offset relative to the other electrode. Consequently, the electric field across the analyte compartment in contemplated configurations may be perpendicular relative to the housing and/or CMM membrane, or at an angle between about 1 degree and 89 degrees, more typically between 15 degrees and 75 degrees, and most typically between 30 degrees and 65 degrees.

Moreover, it should be recognized that contemplated systems may include multiple electrodes, wherein at least some of the electrodes will provide for electrolysis of the medium (preferably electrolysis of water), while other electrodes may form the electric field in which at least part of the analyte compartment is disposed.

There are numerous cation and anion exchange resins for the anode, cathode, and analyte compartments known in the art, and it is contemplated that all known resins are suitable for use in conjunction with the teachings presented herein. An exemplary selection of suitable resins is described, for example, in “Ion Chromatography” by James S. Fritz, Douglas T. Gjerde, in “Ion Exchange : Theory and Practice (Royal Society of Chemistry Paperbacks)” by C. E. Harland (Springer Verlag; ISBN: 0851864848), or in “Ion-Exchange Sorption and Preparative Chromatography of Biologically Active Molecules (Macromolecular Compounds)” by G. V. Samsonov (Consultants Bureau; ISBN: 0306109883).

Particularly contemplated exchange resins for the anode and cathode compartment include those with relatively high stability towards reduction and oxidation of the functional groups under conditions required to separate a desired analyte from a sample fluid, and especially preferred resins for the anode and cathode compartment have a relatively high capacity for H⁺/OH⁻ exchange. Furthermore, it is generally preferred that suitable resins are in solid phase and that at least some of the resin is in contact with the respective electrode.

With respect to a particular cation/anion exchange resin for the analyte compartment, it is generally contemplated that all resins are especially suitable that will bind a desired analyte. There are numerous types of anion and cation exchange resins with various binding strengths known in the art, and it is contemplated a person of ordinary skill in the art will readily identify a particular resin suitable for the analyte without undue experimentation. Furthermore, and especially where the analyte is an amphoteric molecule it should be appreciated that the pH of the fluid containing the analyte may be adjusted according to a particular ion exchange resin.

In still further contemplated aspects, and especially where contemplated devices are configured as CMM buffered electrodialysis devices, the analyte compartment may include both anion and cation exchange resins. While not limiting to the inventive subject matter, it is generally preferred that where the analyte compartment comprises cation and anion exchange resins, the resins are arranged in an ordered sequence. For example, suitable sequences include multiple layers of resins in which a cation exchange resin alternates with an anion exchange resin, and wherein at least some of the resins extend across the entire width of the analyte compartment. Moreover, in such CMM buffered electrodialysis devices it is contemplated that the bifunctional screen may include one or more surface modifications (e.g., non-ionic functional groups and/or aliphatic short chains) to provide some steric hindrance with respect to the surface of the screen. Such modifications are thought to assure a “buffering” effect even for large ionic molecules as such molecules would be forced in a tumbling rather than gliding motion along the screen, whereas small ions should still be able to move among the modifications towards the CMM.

Suitable charge-mosaic membranes may be prepared using numerous methods well known in the art. For example, cation exchange resins may be combined with anion exchange resins using a polystyrene binder (see e.g., U.S. Pat. No. 2,987,472) or a silicone resin (see e.g., J. N. Weinstein et al., Desalination, 12, 1(1973)). Alternatively, suitable membranes may also be fabricated by casting or blending polymer phases (see e.g., J. Shorr et al., Desalination, 14, 11(1974) or Japanese Laid-Open Specification No. 14389/1979). Still further suitable methods include ionotropic-gel membrane methods (see e.g., H. J. Purz, J. Polym. Sci., Part C, 38, 405(1972)), latex-polymer electrolyte methods (see e.g., Japanese Laid-Open Specification No. 18482/1978), or block copolymerization methods (see e.g., Y. Isono et al., Macromolecules, 16, 1(1983)). In yet further contemplated methods, a cationic, anionic, or neutral polymer may be derivatized to include positive and negative charges suitable for ion exchange.

Where cationic and anionic polymers are employed to form a charge mosaic membrane, cationic polymers preferably include primary, secondary or tertiary amino groups, quaternary ammonium groups, or salts thereof, while anionic polymers preferably include sulfonic groups, carboxylic groups or salts thereof. Suitable cationic polymers include polyvinylpyridine and quaternized products thereof; poly(2-hydroxy-3-methacryloyloxypropyltrimethylammonium chloride); poly(dimethylaminoethyl methacrylate), poly(diethylaminoethyl methacrylate), and copolymers with other monomers and/or polymers. Suitable anionic polymers include poly-(2-acryloylamino-2-methyl-1-propanesulfonic acid), poly(2-acryloylamino-2-propanesulfonic acid), polymethacryloyloxypropylsulfonic acid, polysulfopropyl methacrylate, poly(2-sulfoethyl methacrylate), polvinylsulfonic acid, polyacrylic acid, polystyrene-maleic acid copolymers, and copolymers with other monomers and/or polymers.

Furthermore, at least one of the cationic and anionic polymers may be crosslinked using crosslinkers well known in the art. Among numerous alternative crosslinkers, contemplated crosslinkers include divinylbenzene, methylenebisacrylamide, ethylene glycol dimethacrylate and 1,3-butylene glycol dimethacrylate as well as tri- or tetra-functional acrylates and methacrylates. Still further contemplated charge mosaic membranes include those described in U.S. Pat. No. 4,976,860 to Takahashi and U.S. Pat. No. 5,304,307 to Linder et al.

In still further contemplated aspects of the inventive subject matter, it should be recognized that suitable membranes may also be configured to be permeable for charged and non-charged molecules depending on the molecular weight. For example, in such membranes, permeability may be achieved by imparting nanoporosity into the membrane using technologies well known to the person of ordinary skill in the art. Thus, suitable CMM membranes may be a barrier for molecules with various molecular weights, and it is generally contemplated that a particular degree of porosity will predominantly determine the molecular weight cut-off characteristics of such membranes. For example, where relatively small pores are formed in the membrane, suitable molecular weight cut-off may be in the range of between about 300 Da to 3,000 Da. Where somewhat larger porosity is generated, the molecular weight cut-off may be in the range of between about 3,000 Da to 50,000 Da, and where relatively large pores arte generated, the molecular weight cut-off may be in the range of between about 50,000 Da to 200,000 Da, and even higher.

Similarly, it should be recognized that appropriate cation exchange membranes that separate the anode compartment from the analyte compartment include all or almost all of the known cation exchange membranes. However, suitable cation exchange membranes especially include solid polymer electrolyte (SPE) membranes with a relatively high permeability for protons and a relatively low permeability for solvent. There are numerous SPE membranes known in the art, and various aspects of exemplary SPE membranes are described, for example, in U.S. Pat. No. 3,528,858 to Hodgdon et al, U.S. Pat. No. 3,282,875 to Connolly et al, U.S. Pat. No. 5,635,041 to Bahar et al, and U.S. Pat. No. 5,422,411 to Wei et al.

In a further aspect of the inventive subject matter, the origin and composition of contemplated samples may vary considerably, and it is generally contemplated that the origin and composition of the sample is not limiting to the inventive subject matter. However, contemplated samples are preferably processed or unprocessed biological fluids and especially include ionic species of polynucleotides, polypeptides, charged lipids, and/or charged carbohydrates. Thus, contemplated samples may be prepared or isolated from cell cultures, virus and bacterial cultures, animals (and particularly human), plants and/or fungi. Alternatively, suitable samples also include samples from isolated or open environments. For example, samples from isolated environments include process fluids from processing plants (pharmaceutical, food, etc.) while fluids from an open environment may include water samples from a river or other body of water, air, etc.

Furthermore, it should be appreciated that the sample may be provided for various purposes. Among other things, a sample may be provided to remove, reduce the concentration, or determine presence of one or more analytes. Thus, suitable samples may include water, run-off from a process, etc. On the other hand, samples may also be provided to isolate or concentrate one or more analytes. Consequently, suitable samples may include biological fluids, chromatographic preparations, etc.

It is generally preferred, however, that preferred samples include water to at least some degree, and where a particular sample has a relatively low water content (e.g., less than 10 vol %), it is contemplated that the sample may be subjected to a sample preparation step to provide a higher water content. Furthermore, it should be recognized that contemplated samples may be processed to exhibit a particular pH. For example, where an analyte is known to have a neutral charge at a first pH, the pH may be adjusted to an alkaline pH with an appropriate base to facilitate binding of the analyte to the anion exchange resin in the analyte compartment.

Consequently, contemplated analytes will particularly include those that will exhibit an electric charge at a particular pH, and suitable analytes include inorganic analytes, organic analytes, and biological analytes. For example, inorganic analytes include elemental ions (e.g., F⁻, Cl⁻, etc.) and organic and/or inorganic complex ions (e.g., nitrate, carbonate, zirconate, etc.). Organic analytes may include aliphatic, aromatic, and other hydrocarbonaceous ionic molecules, while biological analytes may include ionic forms of nucleic acids, peptides, carbohydrates.

Thus, suitable media particularly include aqueous media, however, in alternative aspects, contemplated media may also include one or more water-miscible or water-immiscible organic solvents. Exemplary contemplated water-miscible organic solvents include dimethylsulfoxide, dimethylformamide, various alcohols, various esters, etc., while exemplary contemplated water-immiscible organic solvents include various aliphatic hydrocarbons, ethers, etc.

With respect to the voltage that is applied to the electrodes, it should be recognized that a particular voltage will typically be determined by various parameters, including salinity of the medium, electrolysis of the medium, and strength of the non-covalent bond between the analyte and the ion exchange resin in the analyte compartment. Thus, suitable voltages will typically be in the range of about less than 1 Volt and several 100 Volts. However, it is generally preferred that the voltage is between about 1 Volt and about 100 Volt, and more typically between 1.4 Volt and about 50 Volt.

It should be particularly appreciated that in the device according to the inventive subject matter continuous conductive pathways for anions and/or cations between the electrodes are present so all physico-chemical processes take place on the surface or the inside of ion-exchange materials (e.g., membranes, screens). As a consequence, the electric impedance of flowing ions is much lower as compared to any other known separation technique. Such configurations allow control of flow of every ion in a highly accurate way, and only water and small quantities of electricity are needed to perform the most complicated analytical and bio-analytical separations. For example because large molecules can be attached and separated on a screen surface, DNA fragments and other biological materials, and even whole microorganisms can be analyzed along with inorganic components. Finally, even ionized isotopes can be separated due to difference of the isotopes' atomic weights.

### CMM Gradient Separation—Membrane Dynamically Scanned Electrophoresis

It should be especially appreciated that the CMM Gradient Separation methods require charge-mosaic membranes. In the CMM Gradient Separation method (e.g., FIG. 1), after sample solution of ionic and non-ionic is injected to the device (and as a result of the ion-exchange process) anions (X₁⁻X₂⁻) are bound to the surface of the anion-exchange resin/screen (130) (smaller anions might diffuse slightly below surface). Electro-neutrality is preserved by appropriate electrode reaction. Co-ions (Y₁⁺Y₂⁺ having the same electric charge sign as the ion-exchange fixed groups on the screen (130) surface, will be forced to move by electric potential outside the Helmholtz/Stern region (outside the electric double layer) on the counter-ions layer (piggy back ride on hydroxyl ions), toward cathode (110) and through anion elements of the CMM (150) to the inside of the electrode chamber, where they will be paired with OH⁻ and flushed away. The OH⁻ ions, generated at the cathode surface, will be transported via anion exchange screen (134) and anion-exchange elements of the CMM (150) and on the surface (and slightly beneath surface) of the anion exchange screen (130) until they reach the surface of the cation-exchange membrane (180), separating the anode compartment (120A) from analyte compartment (130A) where they will be neutralized by H⁺ ions and create water molecules. The analytes X₁⁻ and X₂⁻ are also consecutively paired with H⁺ ions flowing in opposite direction, dislodge from anion-exchange screen and enter the surrounding water and continue to flow in direction of a detector. It is therefore paramount to have non-interfering flows of ionic streams through appropriate elements of the CMM in opposite directions for precise control of the separation process.

CMM Gradient Separation refers to specific “electric gradient” as a characteristic value at which an ion bound to ion-exchange screen starts to move. The electric gradient is roughly the value of potential difference between places on the screen where electric potential is applied (e.g., between places where ion-exchange screen contacts membranes) divided by the length of the screen and will be identical or very close for any ion-exchange screen made from the same components and/or having the same physico-chemical characteristic (for example electric resistivity, mesh size, polymer material, etc.).

The gradient value required for the individual ions, attached to the ion-exchange screen, to start “surface gliding” depends on their size (or molecular weight), geometric shape and electric charge, similarly to capillary electrophoresis where the same factors determine the ionic flow rates and subsequently separation of ionic species. It should be emphasized that other interaction between, especially organic, ions and ion-exchange screen matrix (in this case polymer skeleton with non-ionic chemical groups), like hydrogen bonds and/or Van der Waals forces will also contribute to the total bond strength. Because there is a continuous conductive electric pathway between electrodes (H⁺ OH⁻, as screen counterions), the required electric voltage would be in units of Volts.

CMM Gradient Separation can be performed in two different “modes”, I. Gradient Scanning and II. Set Gradient Separation:

I. Gradient Scanning.

After a sample is injected to the device and ions attach themselves to the screen, an electric potential is applied steadily from zero to a predetermined value. At gradient value G1 anion X₁⁻ then at higher gradient value, G2, anion X₂⁻ start to move toward anode (see FIG. 1). During the time period when the gradient value increases from G1 to G2, the X₁⁻ moving rate increases proportionally (as in classic electrophoresis). X₁⁻ and X₂⁻ will reach the surface of the cation-exchange membrane at different times and thus become separated. The gradient scanning is especially useful when used with another analytic device (e.g., mass spectrometer, and with calibration also with other detector such as conductivity meter, UV-VIS detector, etc.). It should be noted that the CMM Gradient Separation method is very competitive with many separation techniques (e.g., HPLC, ion-chromatography or capillary electrophoresis) as the CMM technique requires only pure water and low-voltage electricity for fast separation, possibly in seconds, with much less limitations then other techniques.

II. Set Gradient Separation.

In this mode, the gradient is increased to a value close but below the G1 value. During this period all ions with lower gradient values will be removed from the device. Then the gradient is set at G1. At this point only X₁⁻ will be removed from the screen and for instance, if it is DNA fragment, it can be directed for further bio-chemical processing. The process can be repeated and at the G2 value where X₂⁻ will be eluted, with unlimited time between these two ions separations, e.g. gradient separation can be stopped and restarted at any time. Additionally, if before starting the gradient separation, water or any other proper solvent is flown through analyte compartment (FIG. 1, 130A), all non-ionic components of the sample can be easily separated for further analysis, or discarded as a waste (sample cleaning). Similarly, bio-chemical agents (FIG. 1, (R)) can be introduced to analyte compartment (160) to perform in situ derivatization, labeling, attaching chromophores or aptamers etc. then clean the analyte compartment with water or organic solvent and then perform Set Gradient Separation.

The Anion-exchange resin (or rather screen—130) preferably have a nanometer-sized layer of anionic polyelectrolyte chemically bonded the surface of an inert material/polymer, because most of the dynamic processes will take place on its surface or slightly beneath surface. As a result, a thick layer of the polyelectrolyte would decrease the ability to control separation via electrophoresis on the surface. (There are many methods to manufacture highly conductive nanometer-deep layer of polyelectrolyte on inert polymers like polyethylene, Teflon, etc., all of which are deemed suitable for use herein). In yet further aspects of the inventive subject matter, it is contemplated that not only anions may be separated, concentrated, or isolated from a complex mixture, but that contemplated configurations may also be employed for cation separation, concentration, and/or isolation. In such configurations, the polarity and arrangement of the ion exchange resins, ion exchange membrane, and the CMM membrane are inverted.

### CMM Buffered Electrodialysis—Dynamically Buffered Electrodialysis

Similarly, in the CMM Buffered Electrodialysis (see FIG. 2) device, H⁺ and OH⁻ ions flow independently and continuously from one electrode to another on the surface or near the surface of the appropriate layers of the mixed bed cation and anion-exchange resins between CMMs and cation or anion-exchange resins in electrode compartments. The specific arrangement of all components of the device allows movement of ions at high current density, a condition necessary to achieve and effectively control separation of specific ionic components of the sample solution via the electro-buffering effect as further described below.

The principle of this separation method is based on the simple fact that the ionic bond strength between the cation- or anion-exchange groups of the device's ion-exchange screen and the ionic species of the separated solution are different as discussed above. In this two-step operation, the sample solution will flow trough the device and both types of ionic species (including amphoteric, like DNA fragments, when only few of one kind ionic group would participate in surface-bonding process), will attach to the appropriate elements of the ion-exchange screen. By increasing the applied electric potential and/or water flow, the analyte ions (B⁺ or X⁻) of the sample will detach from the screen surface and pair with OH⁻ or H⁺ ions respectively, which come from water dissociation in molecular proximity of the analyte ions which are about to be dislodged. By lowering the electric potential the process would be reversed. This mechanism is called “CMM Buffered Electrodialysis”. The paired ions will be released to the water in their order from the lowest to the highest energy bond between the specific ion (and more accurately, counter-ion) and the specific ion-exchange group on the screen (again, electro neutrality is preserved by appropriate electrode reaction). The pairs: B⁺ OH⁻—a base and H⁺ X⁻—an acid, they will enter water at different moments (equivalent of chromatographic elution times).

It should be noted that other ions may glide on surfaces of ion-exchangers (A⁻ and Y⁺—FIG. 2) via the same mechanism as ions in CMM Gradient Electrophoresis. Again, any of those ions attached to the ion-exchange screens will start to glide only at very specific electric potential gradient. But contrary to CMM Gradient Electrophoresis, the counter-ions will enter anode or cathode compartments via appropriate ion-exchange elements of the CMM.

It should further be appreciated that the continuous independent electro-conductive pathways between the electrodes for anions and cations is only possible when CMM are used. There electric current density can be at least ten fold higher at much smaller size of the device. Theoretical purity water is produced as a result of a one-step process. On the other hand, hardness of the demineralized water can be easily controlled by regulating applied voltage and water flow rate, so only part of the ionic components of the demineralized water would be removed. Moreover, due to the high-density current flowing on the anion-exchange screen surface, it will act as a disinfectant present in water without any concentration polarization or fouling (see e.g., Journal of Applied Polymer Science, 1994, vol. 53, no 9, pp. 1245-1249).

Contemplated devices will require only small quantities of electricity and can be configured as a portable desalination device with low energy demand (e.g., can be driven by solar cells/batteries) or configured for household water purification, especially if hazardous ions like perchlorate, chromates, heavy metals salts etc. are present. Of course, it should also be noted that contemplated devices can be used in many others applications beside water demineralization (e.g., for separation of any mixtures of ionic and non-ionic solutes, optionally with one or more surfactant).

It should be appreciated that the present inventive subject matter is fundamentally distinct from electrodeionization (e.g., U.S. Pat. No. 6,929,748). Here, the electrochemical process is used only for regeneration of mixed-bed ion-exchangers. In this process hydronium (H₃O⁺) ions are generated on the surface of an anion-exchange membrane and flow along other cations trapped in the cation-exchanger from one bead to another, then through a cation-exchange membrane to the cathode compartment. The flow of hydroxyl (OH⁻) ions is taking the opposite pathway from the surface of the cation-exchange membrane, via the beads of the anion-exchanger, and end up at the surface of the anion-exchange membrane. Among other disadvantages, such methods are limited to use of low electric current density due to the fact that generation of high density ionic currents at the membrane-beads contact surface would lead to membrane drying, and as a result, prohibitively increase electric resistivity the surface of the membrane and ion-exchange beads. Moreover, such methods require an additional step of preliminary desalination by reverse osmosis, and water flow has to be maintained at a low rate due to slow pace of conventional ion-exchange reaction. Still further, as water dissociation has to take place at both electrode surfaces and at membrane-bead surfaces, such methods are substantially less energy efficient.

### EXAMPLES

The following examples are provided to further illustrate the inventive subject matter, and especially to provide further guidance to a practitioner with respect to CMM gradient separation and CMM buffered electrodialysis. (Membrane Dynamically Scanned Electrophoresis and Dynamically Buffered Electrodialysis).

### CMM Buffered Electrodialysis—Dynamically Buffered Electrodialysis

Device Description:

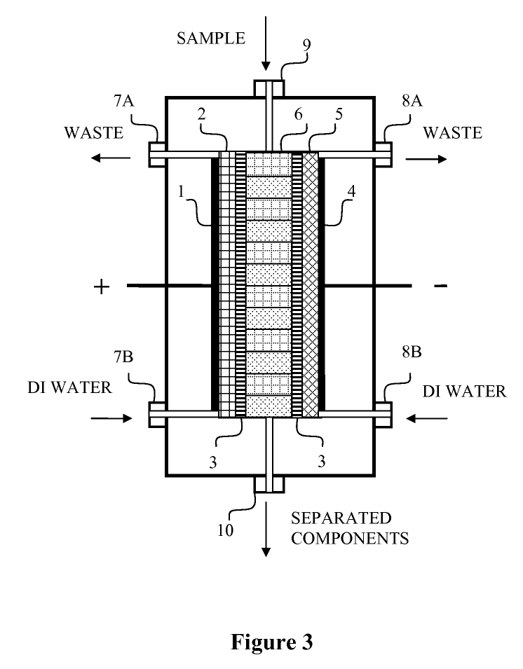

Basic elements of a CMM buffered electrodialysis device are shown in FIG. 3. All ion-exchange materials are made similar to CMM Gradient Separation device. 1—Anode, 2—Anion-exchange screen, 3—Charge mosaic membrane, 4—Cathode, 5—Cation-exchange screen, 6—Bi-charge screen. The screen is prepared by thermally stitching 4 mm wide strips of cation- and anion-exchange screens together. Dimensions 5 cm wide and 20 cm high. 7A and 7B—Anode compartment water flow ports, 8A and 8B—Cathode compartment water flow ports, 9—Sample port, 10—Analyte port.

Continuous Operation Mode:

This mode can be used for water desalination and/or demineralization or for separation inorganic and organic (high molecular weight) component of the solution. Molecular weight cut-off of the organic component of the solution is limited by porosity of relevant elements of charge-mosaic membranes.

Start water flow through anode and cathode compartments using ports 7A and 7B and cathode compartment using ports 8A and 8B at flow rate of 1 mL/min.

Electric potential between anode and cathode is high enough to flow electric current at density of 25 to 50 mA/cm²

After period of stabilization, sample is starting to flow at rate from 0.5 to 20 mL/min. If sample contains only inorganic component, fraction of the desalted water can will be rerouted and flow through anode and cathode compartments. Otherwise, the high molecular weight component would be eluted and flown out through port 10.

Periodic (Batch) Operation Mode:

This mode can be used to separate inorganic and organic component of separated solution.

Start water flow through anode and cathode compartments using ports 7A and 7B and cathode compartment using ports 8A and 8B at flow rate of 0.5 mL/min.

Electric potential between anode and cathode is high enough to flow electric current at density 1 to 5 mA/cm²

Sample of few hundreds milliliters of sample solution is flown through port 9 at rate of 2 mL/min. Total concentration of ionic, organic components (for example proteins) has to be lower then total ion-exchange capacity of analytical anion-exchange bi-charge screen. Inorganic components are removed via charge-mosaic membrane. The organic components of the solution are immobilized on anion- or cation exchange parts of the bi-charge analytical screen.

After sample run is finished, clean water is starting to flow at rate of 0.5 mL/min and electric potential and water flow rate is gradually increased. Consecutively all deposited components are eluted and can be collected.

Notice: Flow of all organic, non-ionic components of the sample through the device is unaffected.

### CMM Gradient Separation (CMM Gradient Electrophoresis)—Membrane Dynamically Scanned Electrophoresis

Device Description:

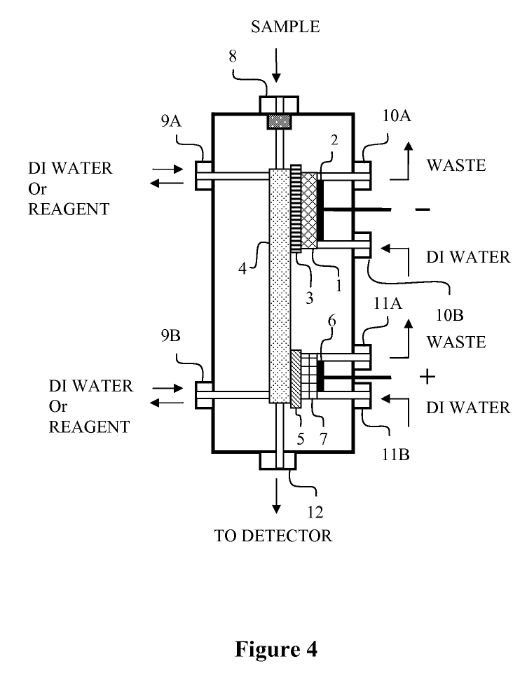

The basic elements of a CMM Gradient Separation device are shown in FIG. 4. 1—Anion-exchange screen in cathode compartment; Grafted poly(chloromethyl-styrene) on polyethylene screen subsequently quaternized with trimethylamine. Surface charge density about 0.05-0.15 meqiv/cm². 2—Cathode made of corrosion-resistant material; 3—Charge-mosaic membrane, separating cathode from analytical compartment, made from modified polyethylene (R. Gajek et al., J. Polym. Sci., Polym. Phys. Ed., Vol. 19, 1663-1673 (1981)). 4—Cation-exchange analytical screen with anionic groups deposited by chemical or irradiative/plasma grafting, layer of anionic polyelectrolyte with thickness of 10 to 1000 nm on surface of inert polymer—same as 1. Dimensions: 1 cm×5cm×0.2 cm. Total resistivity of 20-200 ohm. 5—Cation-exchange membrane separating anode from analytical compartment—any commercially available strong cation-exchange membrane; 6—Anode (made from same material as cathode). 7—Cation-exchange screen in anode compartment—made by grafting of polystyrene on polyethylene screen and subsequent chlorosulfonation and hydrolysis in NaOH solution. Surface charge density about 0.05-0.15 meqiv/cm²; 8—Sample injection port with septum for syringe injection of samples; 9A and 9B—analytical water ports; 10A and 10B—cathode water ports; 11A and 11B—anode water ports; 12—Sample outlet port.

Analytical Mode:

Start water flow through anode compartment using ports 11A and 11B and cathode compartment using ports 10A and 10B at flow rate of 1 mL/min.

Apply electric potential between anode and cathode of 1-2 V.

After period of stabilization, sample of 1.0-50 microL can be injected through port/valve 8.

Depending on the sample composition, dynamic gradient value and duration has to be established for every analysis. At 100 ohm of total system resistivity at 2 V applied potential, current of 20 mA will produce water flow of approximately 0.2 mL/min. At low electric potential (less then 1V) higher water flow can be achieved by flowing additional amount of water through ports 9A and/or 9B. The flow of water trough ports 9A and/or 9B can be regulated using valves. The electric and hydraulic gradient will be gradually increased to create desired “dynamic” gradient. The dynamic gradient can be kept unchanged at certain levels, thus make it possible to elute only one component at a time or scanned, e.g. gradual increase of the dynamic gradient and elute consecutively components attached to the analytical screen or in other words to perform “dynamic scanning”. Small anions, mostly inorganic will diffuse to the inner part of the screen's polyelectrolyte layer and subsequently separated and eluted. Hydraulic component of the dynamic gradient will affect only molecules bound to the surface of the analytical screen.

Cations can be analyzed in corresponding device with cation-exchange analytical screen, while amphoteric molecules can be separated and analyzed in both types of the MDSE device.

Solvent and other neutral, non-ionic molecules can be flushed out from the analytical screen compartment, 4, using water prior to analysis, but also can be analyzed by mixing the sample with proper ionic detergent, binding the non-ionic components and subsequently analyzing the sample in proper type MDSE device.

Separated components can be analyzed using conductivity and/or UV-VIS detectors or can be directly injected to mass spectrum devices. The system can be used for analytical preparative purposes by collecting separated component using variety of laboratory equipment.

Cleaning Procedure (If Necessary):

Start to flow water through analytical compartment using port 9B as an inlet and 9A as an outlet at rate of 2-4 mL/min.

Change polarity of electrodes and apply 2-5 V of electric potential. Notice: in such configuration water electrolysis will occur between cation-exchange membrane (5) and analytical screen (4). Resulting H+ and OH− ions will flow in opposite directions comparing to analytical mode.

Thus, specific embodiments and applications of improved separation systems with charge mosaic membranes have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A separation system comprising:
a cathode, an anode, and a first ion bound by a first ion exchange resin, the first ion exchange resin being at least partially disposed between the cathode and the anode and separated from at least one of the anode and cathode by a charge mosaic membrane;
wherein the cathode, the anode, and the ion exchange resin are at least partially disposed in a medium; and
wherein the system is configured such the first ion is eluted from the resin using (a) a voltage that is applied between the anode and cathode and (b) a second ion that is generated by electrolysis of the medium.

2. The separation system of claim 1 wherein the first ion is an anion, the first ion exchange resin is an anion exchange resin that is separated from the cathode by the charge mosaic membrane, and wherein the second ion is a hydroxyl ion.

3. The separation system of claim 2 wherein the medium comprises water.

4. The separation system of claim 3 wherein the second ion reacts with an H⁺ ion generated at the anode to form water.

5. The separation system of claim 1 further comprising a second ion exchange resin at least partially disposed between the anode and the first ion exchange resin.

6. The separation system of claim 5 further comprising a cation exchange membrane at least partially disposed between the first and second ion exchange resin.

7. The separation system of claim 6 wherein the charge mosaic membrane is at least partially disposed between the cathode and the first ion exchange resin.

8. A separation system comprising an ion exchange resin that binds an ion from a fluid, wherein the system is configured such that the ion is eluted from the resin using (a) an electric field generated between an cathode and a anode and (b) a second ion that is generated by electrolysis of the fluid by the cathode and the anode.

9. The separation system of claim 8 wherein a charge mosaic membrane separates the ion exchange resin from the cathode, thereby allowing migration of OH⁻ ions from the cathode to the ion exchange resin and migration of cations from the ion exchange resin to the cathode.

10. The separation system of claim 9 wherein elution of the ion from the fluid further comprises addition of a derivatization agent or a solvent.

11. The separation system of claim 8 wherein the ion exchange resin comprises an anion exchange resin, and wherein the ion is an anion.

12. The separation system of claim 8 wherein the fluid comprises a biological fluid and wherein the ion comprises at least one of a polynucleotide, a polypeptide, a charged lipid, and a charged carbohydrate.

13. The separation system of claim 8 further comprising a third ion that binds to the ion exchange resin, wherein the third ion elutes at an electric field and concentration of the second ion that is different from the elution of the ion from the fluid.

14. A separation system comprising a charge mosaic membrane coupled to an ion exchange resin that allows binding of an ion from a fluid and wherein the system is configured such that the ion is eluted at least in part from the resin using an eluent that is generated by electrolysis of the fluid.

15. The separation system of claim 14 wherein the resin comprises an anion ion exchange resin, and wherein the eluent is an OH⁻ ion.

16. The separation system of claim 14 wherein electrolysis is performed by a current applied to an anode and a cathode, wherein the anode and the cathode are at least partially disposed in the fluid, wherein the resin is at least partially disposed between the anode and the cathode.

17. The separation system of claim 16 wherein elution of the ion is assisted by an electrical field generated between the anode and the cathode.

18. The separation system of claim 14 wherein the fluid comprises a biological fluid and wherein the ion comprises at least one of a polynucleotide, a polypeptide, a charged lipid, and a charged carbohydrate.

19. The separation system of claim 14 wherein elution is further assisted by addition of a second ion to the ion exchange resin.

20. The separation system of claim 19 wherein the second ion is an anion.
